(19) United States
(12) Patent Application Publication
(10) Pub. No.: US 2022/0311690 A1
(43) Pub. Date: Sep. 29, 2022

(54) AUDITOR FOR OPEN TCP/UDP PORTS ON NETWORK INTERFACES

(71) Applicants: Yongqiang YE, Guangdong Shenzhen (CN); ARRIS Enterprises LLC, Suwanee, GA (US)

(72) Inventor: Yongqiang YE, Shenzhen (CN)

(21) Appl. No.: 17/292,929

(22) PCT Filed: May 20, 2020
(86) PCT No.: PCT/CN2020/091358

§ 371 Date: May 11, 2021

(51) Int. Cl. H04L 43/0876; H04L 41/28; H04L 69/28; H04L 69/16; H04L 9/40

(52) U.S. Cl. CPC H04L 43/0876; H04L 41/28; H04L 69/28; H04L 69/161; H04L 63/0236

(57) ABSTRACT

A network device for use with a network. The network device includes a memory and a processor configured to execute instructions stored on the memory, to cause the network device to: open a port to enable at least one of enabling outbound communication to exit out of the network device and into the network, and enabling inbound communication to enter into the network device from the network; start a port timer based on the opening of the port; reset the port timer based on at least one of the outbound communication exiting into the network and the inbound communication entering from the network; and perform a port auditing action based on the port timer reaching a threshold.

### BACKGROUND

Embodiments of the invention relate to inbound and outbound communications through a network device.

### SUMMARY

Aspects of the present invention are drawn to a network device for use with a network. The network device includes a memory and a processor configured to execute instructions stored on the memory, to cause the network device to: open a port to enable at least one of enabling outbound communication to exit out of the network device and into the network, and enabling inbound communication to enter into the network device from the network; start a port timer based on the opening of the port; reset the port timer based on at least one of the outbound communication exiting into the network and the inbound communication entering from the network; and perform a port auditing action based on the port timer reaching a threshold.

In some embodiments, the processor is further configured to execute instructions stored on the memory to cause the network device to perform the port auditing action by logging of the port timer reaching the threshold into a system log.

In some embodiments, the processor is further configured to execute instructions stored on the memory to cause the network device to perform a second port auditing action based on the port timer reaching a second threshold. Additionally, the processor may be further configured to execute instructions stored on the memory to cause the network device to perform the second port auditing action by closing the port.

Other aspects of the present invention are drawn to a method of using a network device with a network, the method comprising: opening, via a processor configured to execute instructions stored on a memory, a port to enable at least one of enabling outbound communication to exit out of the network device and into the network and enabling inbound communication enter into the network device from the network; starting, via the processor, a port timer based on the opening of the port; resetting, via the processor, the port timer based on at least one of the outbound communication exiting into the network and the inbound communication entering from the network; and performing, via the processor, a port auditing action based on the port timer reaching a threshold.

In some embodiments, the performing the port auditing action comprises logging of the port timer reaching the threshold into a system log.

In some embodiments, the method further comprises performing a second port auditing action based on the port timer reaching a second threshold. Additionally, the performing the second port auditing action may comprise closing the port.

Other aspects of the present invention are drawn to a non-transitory, computer-readable media having computer-readable instructions stored thereon, the computer-readable instructions being capable of being read by a network device for use with a network, wherein the computer-readable instructions are capable of instructing the network device to perform the method comprising: opening, via a processor configured to execute instructions stored on a memory, a port to enable at least one of enabling outbound communication to exit out of the network device and into the network and enabling inbound communication enter into the network device from the network; starting, via the processor, a port timer based on the opening of the port; resetting, via the processor, the port timer based on at least one of the outbound communication exiting into the network and the inbound communication entering from the network; and performing, via the processor, a port auditing action based on the port timer reaching a threshold.

In some embodiments, the computer-readable instructions are capable of instructing the network device to perform the method wherein the performing the port auditing action comprises logging of the port timer reaching the threshold into a system log.

In some embodiments, the computer-readable instructions are capable of instructing the network device to perform the method further comprising performing a second port auditing action based on the port timer reaching a second threshold. Additionally, the computer-readable instructions may be capable of instructing the network device to perform the method wherein the performing the second port auditing action comprises closing the port

### BRIEF SUMMARY OF THE DRAWINGS

The accompanying drawings, which are incorporated in and form a part of the specification, illustrate example embodiments and, together with the description, serve to explain the principles of the invention. In the drawings:

FIG. 1A illustrates a portion of a conventional network;

FIG. 1B further illustrates the portion of the network of FIG. 1A;

FIG. 1C further illustrates the portion of the network of FIG. 1B;

FIG. 2A illustrates a portion of a network in accordance with aspects of the present disclosure;

FIG. 2B further illustrates a portion of the network of FIG. 2A;

FIG. 3 illustrates a method of auditing ports in a network device; and

FIG. 4 illustrates an exploded view of the network device.

### DETAILED DESCRIPTION

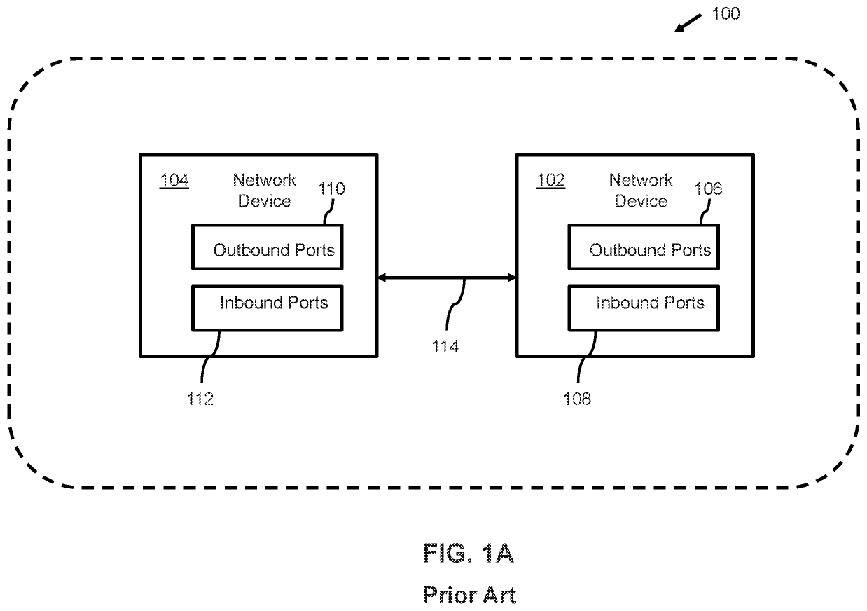

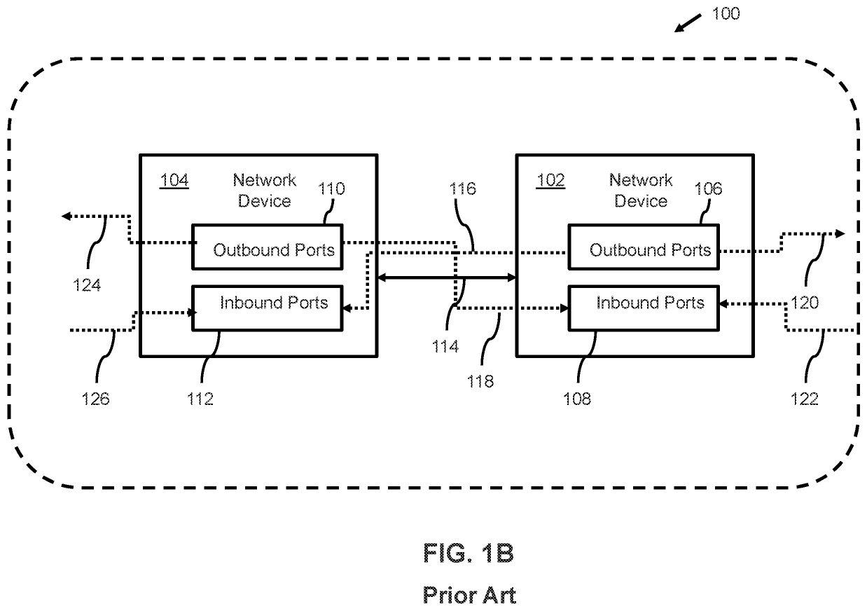

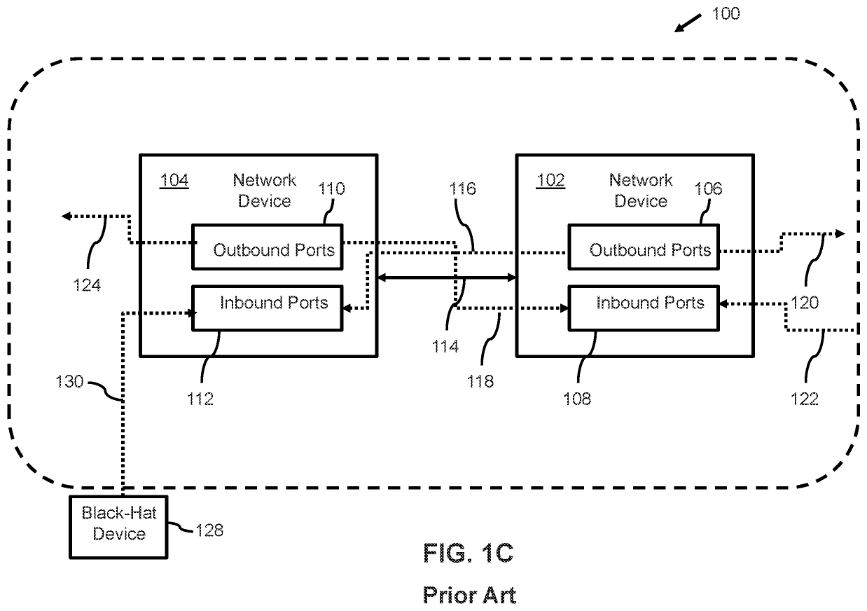

FIG. 1A illustrates a portion of a conventional network 100.

As shown in the figure, network 100 includes a network device 102, a network device 104, and a communication channel 114. Network device 102 includes a plurality of outbound ports 106 and a plurality of inbound ports 108. Network device 104 includes a plurality of outbound ports 110 and a plurality of inbound ports 112.

Network device 102 is arranged to communicate with network device 104 by way of communication channel 114.

As a whole, network device 104 is configured to enable communications with respect to network device 102, by way of network 100. Inbound ports 112 enable communications that are inbound into network device 104 from external network devices, such as network device 102, by way of network 100. Outbound ports 110 enable communications that are outbound from network device 104 to external network devices, such as network device 102, by way of network 100.

In computer networking, a port is a communication endpoint. At the software level, within an operating system, a port is a logical construct that identifies a specific process or a type of network service. Ports are identified for each protocol and address combination by 16-bit unsigned numbers, commonly known as the port number. The most common protocols that use port numbers are the Transmission Control Protocol (TCP) and the User Datagram Protocol (UDP).

A port number is always associated with an IP address of a host and the protocol type of the communication. It completes the destination or origination network address of a message. Specific port numbers are commonly reserved to identify specific services, so that an arriving packet can be easily forwarded to a running application. For this purpose, the lowest numbered 1024 port numbers identify the historically most commonly used services, and are called the well-known port numbers. Higher-numbered ports are available for general use by applications and are known as ephemeral ports.

When used as a service enumeration, ports provide a multiplexing service for multiple services or multiple communication sessions at one network address. In the client—server model of application architecture multiple simultaneous communication sessions may be initiated for the same service.

A port number is a 16-bit unsigned integer, thus ranging from 0 to 65535. For TCP, port number 0 is reserved and cannot be used, while for UDP, the source port is optional and a value of zero means no port. A process associates its input or output channels via an Internet socket, which is a type of file descriptor, with a transport protocol, an IP address, and a port number. This is known as binding, and enables the process to send and receive data via the network. The operating system's networking software has the task of transmitting outgoing data from all application ports onto the network, and forwarding arriving network packets to processes by matching the packet's IP address and port number. For TCP, only one process may bind to a specific IP address and port combination. Common application failures, sometimes called port conflicts, occur when multiple programs attempt to use the same port number on the same IP address with the same protocol.

Applications implementing common services often use specifically reserved well-known port numbers for receiving service requests from clients. This process is known as listening, and involves the receipt of a request on the well-known port and establishing a one-to-one server-client dialog, using the same local port number. Other clients may continue to connect to the listening port; this works because a TCP connection is identified by a tuple consisting of the local address, the local port, the remote address, and the remote port. The well-known ports are defined by convention overseen by the Internet Assigned Numbers Authority (IANA). The core network services, such as the World Wide Web, typically use well-known port numbers. In many operating systems special privileges are required for applications to bind to these ports, because these are often deemed critical to the operation of IP networks. Conversely, the client end of a connection typically uses a high port number allocated for short term use, therefore called an ephemeral port.

Transport layer protocols, such as the Transmission Control Protocol (TCP) and the User Datagram Protocol (UDP), transfer data using protocol data units (PDUs). For TCP, the PDU is a segment, and a datagram for UDP. Both protocols use a header field for recording the source and destination port number. The port numbers are encoded in the transport protocol packet header, and they can be readily interpreted not only by the sending and receiving computers, but also by other components of the networking infrastructure. In particular, firewalls are commonly configured to differentiate between packets based on their source or destination port numbers. Port forwarding is an example application of this.

The practice of attempting to connect to a range of ports in sequence on a single computer is commonly known as port scanning. This is usually associated either with malicious cracking attempts or with network administrators looking for possible vulnerabilities to help prevent such attacks. Port connection attempts are frequently monitored and logged by computers. The technique of port knocking uses a series of port connections (knocks) from a client computer to enable a server connection.

FIG. 1B further illustrates the portion of network 100 of FIG. 1A, with the addition of inbound communications and outbound communications to and from network devices 102 and 104.

As shown in FIG. 1B, network device 102 is arranged to transmit a communication 116, receive a communication 118, transmit an outbound communication 120, and receive an inbound communication 122. Network device 104 is arranged to transmit communication 118, receive communication 116, transmit an outbound communication 124, and receive an inbound communication 126.

Communication channel 114 transmits communications 116 and 118 between network device 102 and network device 104. Communication 116 is an outbound communication from network device 102, and an inbound communication to network device 104. Communication 118 is an outbound communication from network device 104, and an inbound communication to network device 102.

FIG. 1C further illustrates the portion of network 100 of FIG. 1B, with the addition of a black-hat device 128.

As shown in FIG. 1C, black-hat device 128 is arranged to communicate with network device 104. In FIG. 1C, a communication 130 is shown as an inbound communication to network device 104.

Black-hat device 128 is arranged to transmit inbound communication 130 to network device 104.

An open port always represents an increased security threat, even when the port is open intentionally. For example, remote management via an HTTP web, such as the internet, may be helpful for temporary remote control of a network device 104. If an open port is dormant for a very long time, it may be because its open condition is unknown to the network, and typically is not needed to be open permanently. In general, it is not a good idea for ports to be open permanently, and it should be considered a serious security threat if one is open and dormant for a long duration, such as for days or weeks.

Unnecessarily open TCP/UDP ports on a network interface are a significant threat to the security of the networked devices within a network, particularly for those interfaces that are exposed to a public network. One strategy used by black-hats, or criminals that break into computer networks with malicious intent, in their attempt to gain root account access within that network, is to gain access to an already-open TCP/UDP port in a network device.

Some conventional network auditing tools may scan the full range of ports numbered 0 through 65535 to detect open ports of a network device. However, these conventional network auditing tools have many drawbacks that are associated with such scanning. It is time consuming, particularly when the scanned system implements some protection mechanism against scanning. Also, scanning for open ports cannot, in itself, determine whether an open port is proper, required, and expected.

Thus, it is important for increased network security to provide an audit processor that detects ports that are open when they do not need to be open, and implement a mechanism to close those ports. Desirably, this audit processor also alerts a user when an open port is detected and closed.

What is needed is a system and method for solving the problem posed to network security by unnecessarily open network device ports.

A system and method in accordance with the present disclosure solves the problem posed to network security by unnecessarily open network device ports.

In accordance with the present invention, an audit processor starts a port timer when a listening port is opened by the IP stack. The timer is reset to zero when valid communication traffic arrives at the port. Valid communication traffic may be detected for TCP communication when the TCP connection is established. Valid communication traffic may be detected for UDP communication when the response packet is sent out from the listening port. When the timer count exceeds a shorter duration, for example one week, the audit processor logs this event, such as in a user log, syslog, or SNMP log. When the timer count exceeds a longer duration, for example four weeks, the audit processor closes the open port by adding new rules to the firewall, for example to the IP tables, and logs this event. The timer may be configurable via management interface. The audit processor may be enabled/disabled via a management interface. The audit processor may not close the ports that provide key management service, for example port 80 for communication with a GUI on a LAN interface, or to a user in the cloud. A user may use the management interface to view the ports closed by the audit processor. A user may be allowed to add a port to a white list, wherein the audit processor would not block the ports in the white list.

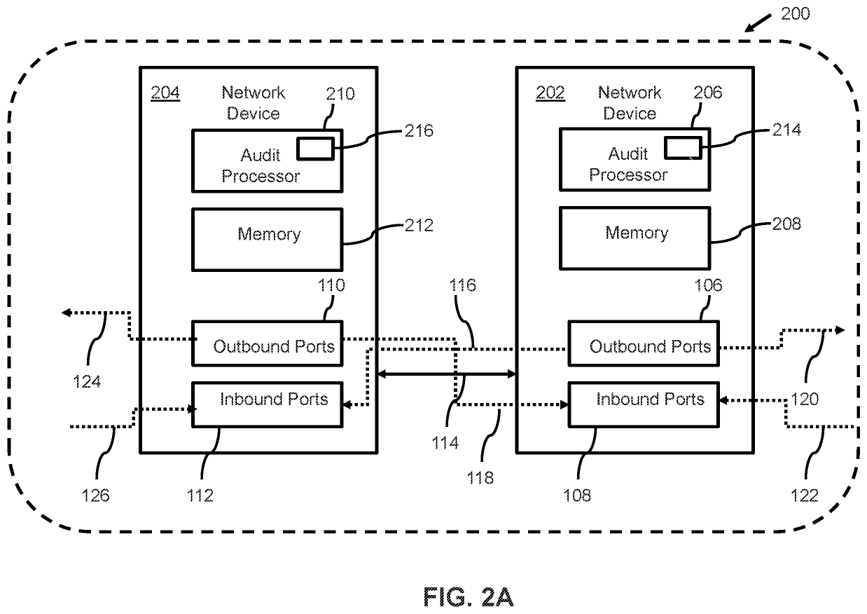

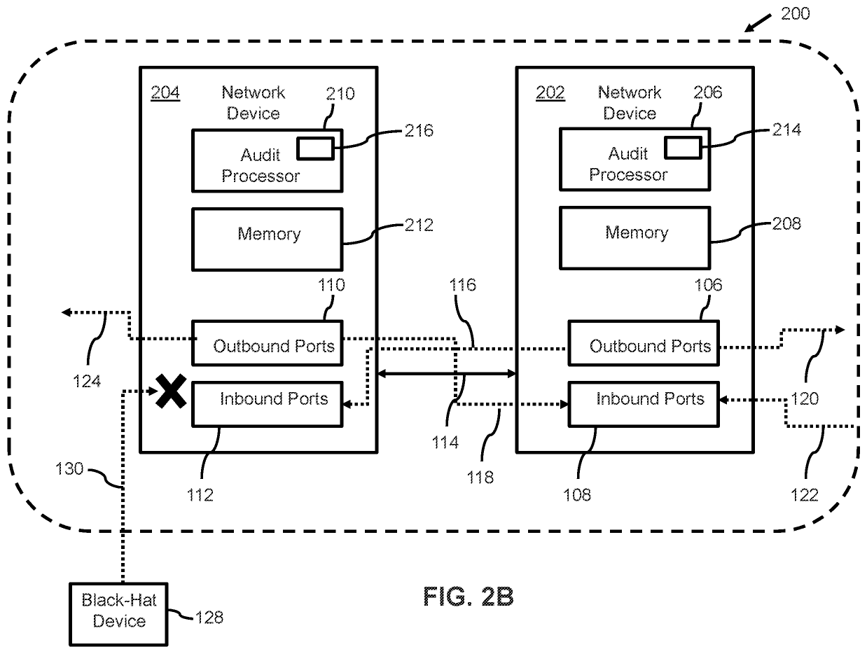

An example system and method for providing an audit processor that detects ports that are open when they have been open for a predetermined extended period of time without use, and closing those ports, in accordance with aspects of the present disclosure will now be described in greater detail with reference to FIGS. 2A-4.

FIG. 2A illustrates a portion of a network 200, in accordance with aspects of the present disclosure.

As shown in the figure, network 200 includes a network device 202, a network device 204, and communication channel 114. Network device 202 includes an audit processor 206, a memory 208, plurality of outbound ports 108, and plurality of inbound ports 106. Audit processor 206 includes a port timer 214. Network device 204 includes an audit processor 210, a memory 212, plurality of outbound ports 110, and plurality of inbound ports 112. Audit processor 210 includes a port timer 216. Network device 202 includes communication 116, communication 118, output communication 120, and input communication 122. Network device 204 includes communication 118, communication 116, output communication 124, and input communication 126.

Network device 202 is arranged to communicate with network device 204 by way of communication channel 114. Communication channel 114 enables communications 116 and 118. Communication 116 is an output communication from network device 202, and an input communication to network device 204. Communication 118 is an output communication from network device 204, and an input communication to network device 202.

In this example, inbound ports 108, outbound ports 106, memory 208, and audit processor 206 are illustrated as individual devices of network device 202. However, in some embodiments, at least two of inbound ports 108, outbound ports 106, memory 208, and audit processor 206 may be combined as a unitary device. Further, in some embodiments, at least one of inbound ports 108, outbound ports 106, memory 208, and audit processor 206 may be implemented as a computer having non-transitory computer-readable media for carrying or having computer-executable instructions or data structures stored thereon. Such non-transitory computer-readable recording medium refers to any computer program product, apparatus or device, such as a magnetic disk, optical disk, solid-state storage device, memory, programmable logic devices (PLDs), DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Example tangible computer-readable media may be coupled to a processor such that the processor may read information from, and write information to the tangible computer-readable media. In the alternative, the tangible computer-readable media may be integral to the processor. The processor and the tangible computer-readable media may reside in an integrated circuit (IC), an application specific integrated circuit (ASIC), or large scale integrated circuit (LSI), system LSI, super LSI, or ultra LSI components that perform a part or all of the functions described herein. In the alternative, the processor and the tangible computer-readable media may reside as discrete components.

Example tangible computer-readable media may be also be coupled to systems, non-limiting examples of which include a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Such a computer system/server may be described in the general context of computer system-executable instructions, such as program modules, being executed by a computer system. Generally, program modules may include routines, programs, objects, components, logic, data structures, and so on that perform particular tasks or implement particular abstract data types. Further, such a computer system/server may be practiced in distributed cloud computing environments where tasks are performed by remote processing devices that are linked through a communications network. In a distributed cloud computing environment, program modules may be located in both local and remote computer system storage media including memory storage devices.

Components of an example computer system/server may include, but are not limited to, one or more processors or processing units, a system memory, and a bus that couples various system components including the system memory to the processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

A program/utility, having a set (at least one) of program modules, may be stored in the memory by way of example, and not limitation, as well as an operating system, one or more application programs, other program modules, and program data. Each of the operating system, one or more application programs, other program modules, and program data or some combination thereof, may include an implementation of a networking environment. The program modules generally carry out the functions and/or methodologies of various embodiments of the application as described herein.

As a whole, network device 204 is configured to enable communications with respect to network device 202, by way of network 200. Inbound ports 112 enable communications that are inbound into network device 204 from external network devices, such as network device 202, by way of network 200. Outbound ports 110 enable communications that are outbound from network device 204 to external network devices, such as network device 202, by way of network 200.

Memory 212, as will be described in greater detail below, has instructions stored thereon to enable audit processor 210 to perform operations. Audit processor 210, as will be described in greater detail below, is configured to execute the instructions stored in memory 212 to perform an operation, non-limiting examples of which include: opening a port to enable at least one of enabling outbound communications to exit out of network device 204 and enabling inbound communications to enter into network device 204; starting port timer 216 based on an opening of a port; resetting port timer 216 based on at least one of an outbound communication exiting network device 204 and an inbound communication entering network device 204; and performing a port auditing action based on port timer 216 reaching a threshold and combinations thereof.

Audit processor 210, as will be described in greater detail below, is additionally configured to execute the instructions stored in memory 212 to enable network device 204 to perform the port auditing action by logging of port timer 216 reaching the threshold into a system log.

Audit processor 210, as will be described in greater detail below, is additionally configured to execute the instructions stored in memory 212 to enable network device 204 to perform the port auditing action based on port timer 216 reaching a second threshold.

Audit processor 210, as will be described in greater detail below, is additionally configured to execute the instructions stored in memory 212 to enable network device 204 to perform a second port auditing action by closing a port.

A method of operating a network device 204 in accordance with aspects of the present invention will now be described with reference to FIGS. 2A-4.

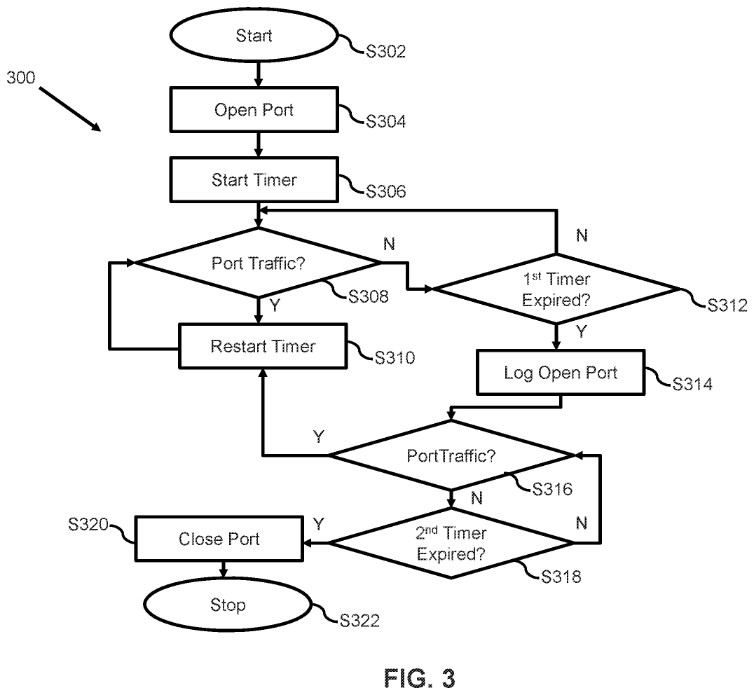

FIG. 3 illustrates a method 300 of auditing ports in a network device, in accordance with aspects of the present disclosure.

As shown in the figure, method 300 starts (S302), and a port is opened (S304). For example, returning to FIG. 2A, network device 204 opens at least one of outbound ports 110 and one of inbound ports 112.

For purposes of discussion only, an example will be described wherein network device 204 wants to communicate with network device 202 by way of communication channel 114. While enabling such communication, network device 204 is going to enable one of inbound ports 112 to be open to enable communication with network device 202.

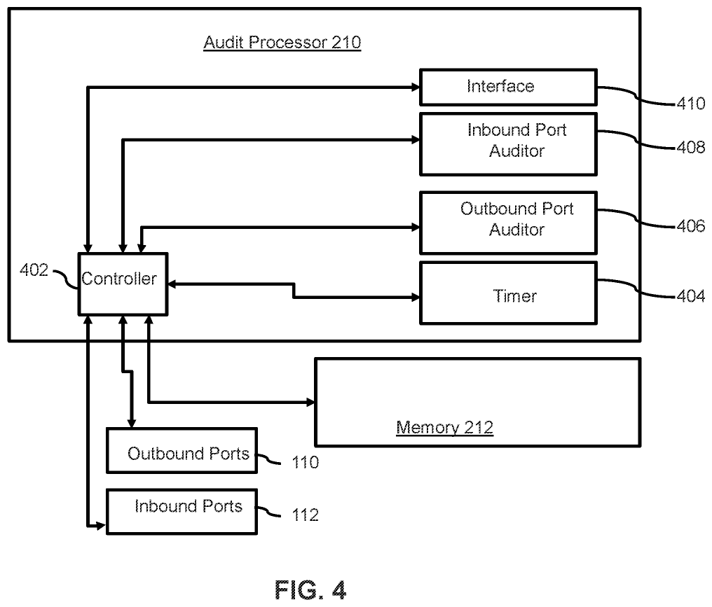

Returning to FIG. 3, after a port has been opened (S304), a port timer is started (S306). For example, returning to FIG. 2A, audit processor 210 of network device 204 starts a port timer 216. This will be described in greater detail with reference to FIG. 4.

FIG. 4 illustrates an exploded view of network device 204.

As shown in the figure, network device 204 includes audit processor 210, memory 212, plurality of outbound ports 110, and plurality of inbound ports 112. Audit processor 210 includes a controller 402, a timer 404, an outbound port auditor 406, an inbound port auditor 408, and an interface circuit 410.

Controller 402 is arranged to be in communication with inbound ports 112, outbound ports 110, memory 212, timer 404, outbound port auditor 406, inbound port auditor 408, and interface circuit 410.

In this example, outbound ports 110, inbound ports 112, memory 212, audit processor 210, controller 402, timer 404, outbound port auditor 406, inbound port auditor 408, and interface circuit 410 are illustrated as individual devices. However, in some embodiments, at least two of outbound ports 110, inbound ports 112, memory 212, audit processor 210, controller 402, timer 404, outbound port auditor 406, inbound port auditor 408, and interface circuit 410 may be combined as a unitary device. Further, in some embodiments, at least one of outbound ports 110, inbound ports 112, memory 212, audit processor 210, controller 402, timer 404, outbound port auditor 406, inbound port auditor 408, and interface circuit 410 may be implemented as a computer having non-transitory computer-readable media for carrying or having computer-executable instructions or data structures stored thereon.

Controller 402 can include a dedicated control circuit, CPU, microprocessor, etc. Controller 402 controls operation of each of inbound ports 112, outbound ports 110, memory 212, timer 404, outbound port auditor 406, inbound port auditor 408, and interface circuit 410. Interface circuit 410 enables a user to interface with network controller 204. Memory 212 can store various programming, and user content, and data. Inbound port auditor 408 audits inbound ports 112. Outbound port auditor 406 audits outbound ports 110. Timer 404 establishes and manages port timers, as will be described in greater detail below. In some embodiments, at least one of inbound port auditor 408 and outbound port auditor 406 may be enabled and disabled via interface circuit 410.

Timer 404 starts a port timer based on a start timer triggering event, non-limiting examples of which include an opening of an inbound port of inbound ports 112 and an opening of an outbound port of outbound ports 110. Starting a port timer can occur when a port is opened, a predetermined time after the port is opened, or after another triggering event after the port is opened. A port timer can be reset based on a reset triggering event, non-limiting examples of which include an outbound communication exiting from network device 204 and an inbound communication entering into network device 204.

Resetting a port timer can occur after any one of one or more predetermined time or times after a port is opened, or after another reset triggering event after the port is opened, or any combination of a predetermined time and a reset triggering event. In an example embodiment, a port timer may be set to expire after one week. The purpose of this port timer may be to enable network device 204 to know that a port has been open for one week while no communication has passed through it. This will be described in more detail below.

In some embodiments, there may be two timers. For example, one port timer may be a logging port timer, which may generally expire after a shorter period of time, for example for one day to one week. Another timer may be a closing port timer, which may generally expire after longer period of time, for example for two weeks to one month, after which the port may be closed. In other embodiments, a single timer may be used with two different timing thresholds. In some embodiments, the duration of a port timer, or the durations of the two port timers, may be configurable via interface circuit 410.

Returning to FIG. 3, after a port timer has been started (S306), it is determined whether there has been port communication (S308). For example, returning to FIG. 4, inbound port auditor 408 audits inbound communications through inbound ports 112. Auditing inbound communication includes determining if any inbound communication has occurred through any inbound ports 112. Further, outbound port auditor 406 audits outbound communications through outbound ports 110. Auditing outbound communication includes determining if any outbound communication has occurred through any outbound ports 110.

Returning to FIG. 3, if it is determined that no port communication has entered into or left network device 204 (N at S308), then it is determined whether the first timer has expired (S312). For example, returning to FIG. 4, if inbound port auditor 408 or outbound port auditor 406 determine that no communication has passed through the inbound ports 112 or outbound ports 110, it is determined that no port communication has entered or left network device 204.

Returning to FIG. 3, after a decision is made whether there has been port communication (S308), if there has not been port communication then a decision is made whether a first timer is expired (S312). For example, returning to FIG. 4, it is determined whether port timer 216, established by timer 404 in network device 204, has reached a predetermined time for the logging of port timer 216.

Returning to FIG. 3, if it is determined that the first timer has not expired (N at S312), then the process returns to again determine whether there has been port communication (return to S308).

Returning to FIG. 3, after a decision is made whether there has been port communication (S308), if there has been port communication (Y at S308), then a port timer is restarted (S310). For example, returning to FIG. 4, controller 402 instructs timer 404 to restart the previously established port timer (from S306) if it has been determined there has been communication through outbound ports 110 or inbound ports 112.

Returning to FIG. 3, after the timer has restarted (S310), method 300 returns to again determine whether there has been port communication (return to S308).

As shown in the figure, if it is determined that the first timer is expired (Y at S312), then the open port is logged (S314). For example, returning to FIG. 4, in one embodiment outbound port auditor 406 informs controller 402 that an outbound port is still open after the expiration of a port timer. In another embodiment, controller 402 then logs the details of the open port in memory 212. This log may be, for example, one or more of a user log, syslog, or SNMP log. In another embodiment, controller 402 alerts a user via interface circuit 410 that an outbound port is still open after the expiration of a port timer.

Returning to FIG. 3, after an open port has been logged (S314), a decision is made whether there has been port communication (S316). For example, returning to FIG. 4, inbound port auditor 408 audits inbound communication through inbound ports 112. Further, outbound port auditor 406 audits outbound communication through outbound ports 110.

Returning to FIG. 3, if it is determined that no port communication has entered into or left network device 204 (N at S316), then it is determined whether the second timer has expired (S318). For example, returning to FIG. 4, if inbound port auditor 408 or outbound port auditor 406 determine that no communication has passed through the inbound ports 112 or outbound ports 110, it is determined that no port communication has entered or left network device 204.

Returning to FIG. 3, if it is determined that there has been no port communication (S316), then it is determined whether a second timer is expired (S318). In some embodiments, there may be two timers. For example, returning to FIG. 4, it is determined whether a second port timer, established by timer 404 in network device 204, has reached the predetermined time for the closing port timer.

In other embodiments, a single timer may be used with two different timing thresholds. For example, it is determined whether the single port timer, established by timer 404 in network device 204, has reached a second predetermined timing threshold.

Returning to FIG. 3, if it is determined that the second timer has not expired (N at S318), then method 300 determines whether there has been port communication (return to S316).

Returning to FIG. 3, if it is determined that there has been port communication (Y at S316), then an existing timer is restarted (S310). For example, returning to FIG. 4, controller 402 instructs timer 404 to restart if it has been determined there has been communication through outbound ports 110 or inbound ports 112.

Returning to FIG. 3, if it is determined that the second timer is expired (Y at S318), then the open port is closed (S320). For example, returning to FIG. 4, in one embodiment after the expiration of a port timer, outbound port auditor 406 informs controller 402 that an outbound port needs to be closed. Returning to FIG. 2A, in one embodiment audit processor 210 blocks the port by adding new rules to a firewall, for example by modifying its IP tables. In some embodiments, audit processor 210 may not close the ports that provide key management service, for example port 80 for communication with a GUI on a LAN interface, or to a user in the cloud.

Returning to FIG. 4, interface circuit 410 may be used by a user to view the ports blocked by audit processor 210. A user may be allowed to add a port to a white list, wherein audit processor 210 would not block the ports in the white list. In one embodiment, controller 402 may additionally log the details of closing the open port into memory 212. In one embodiment, controller 402 may alert a user via interface circuit 410 that an outbound port had remained open after the expiration of a port timer, and has since been closed.

FIG. 2B further illustrates a portion of network 200 of FIG. 2A, and a black-hat device 128.

As shown in FIG. 2B, black-hat device 128 is arranged to communicate with network device 204. In FIG. 2B, input communication 130 is shown as an input communication to network device 204.

Black-hat device 128 is illustrated as being arranged to attempt to communicate with network device 204 by way of input communication 130.

In accordance with aspects of the present disclosure, a previously open port within inbound ports 112, which has been determined by audit processor 210 to have not been used for a predetermined period of time, has since been closed by audit processor 210. Accordingly, black hat device 128 is unable to access inbound ports 112. Therefore, audit processor 210 has successfully decreased the chances of network attacks through unnecessarily open ports by black hat hackers.

Returning to FIG. 3, after a port has been closed (S320), method 300 stops (S322).

Unnecessarily open ports on a network interface are a significant threat to the security of the networked devices within a network, as black-hats may gain access to an already-open port. Conventional network auditing tools have many drawbacks that are associated with scanning for open ports. Such scanning is time consuming, and scanning for open ports cannot, in itself, determine whether an open port is proper, required, and expected. Thus, it is important for increased network security to provide an audit processor that detects ports that are open when they do not need to be open, and implement a mechanism to close those ports.

In accordance with the present invention, an audit processor starts a port timer when a listening port is opened by the IP stack. The timer is reset to zero when valid communication traffic arrives at the port. When the timer count exceeds a first duration, the audit processor logs this event. When the timer count exceeds a second duration, the audit processor closes the open port, and logs this event.

Thus, the present invention as disclosed increases network security while avoiding the drawbacks of the prior art, by determining ports that are open when they do not need to be open, and implementing a mechanism to close those ports.

The foregoing description of various preferred embodiments have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A network device for use with a network, said network device comprising:
a memory; and
a processor configured to execute instructions stored on said memory to cause said network device to:
open a port to enable at least one of enabling outbound communication to exit out of said network device and into the network and enabling inbound communication to enter into said network device from the network,
start a port timer based on the opening of the port,
reset the port timer based on at least one of the outbound communication exiting into the network and the inbound communication entering from the network, and
perform a port auditing action based on the port timer reaching a threshold.

2. The network device of claim 1, wherein the processor is further configured to execute instructions stored on said memory to cause said network device to perform the port auditing action by logging of the port timer reaching the threshold into a system log.

3. The network device of claim 1, wherein the processor is further configured to execute instructions stored on said memory to cause said network device to perform a second port auditing action based on the port timer reaching a second threshold.

4. The network device of claim 3, wherein the processor is further configured to execute instructions stored on said memory to cause said network device to perform the second port auditing action by closing the port.

5. A method of using a network device with a network, said method comprising:
opening, via a processor configured to execute instructions stored on a memory, a port to enable at least one of enabling outbound communication to exit out of said network device and into the network and enabling inbound communication enter into said network device from the network;
starting, via the processor, a port timer based on the opening of the port;
resetting, via the processor, the port timer based on at least one of the outbound communication exiting into the network and the inbound communication entering from the network; and
performing, via the processor, a port auditing action based on the port timer reaching a threshold.

6. The method of claim 5, wherein said performing the port auditing action comprises logging of the port timer reaching the threshold into a system log.

7. The method of claim 5, further comprising performing a second port auditing action based on the port timer reaching a second threshold.

8. The method of claim 7, wherein said performing the second port auditing action comprises closing the port.

9. A non-transitory, computer-readable media having computer-readable instructions stored thereon, the computer-readable instructions being capable of being read by a network device for use with a network, wherein the computer-readable instructions are capable of instructing the network device to perform the method comprising:
opening, via a processor configured to execute instructions stored on a memory, a port to enable at least one of enabling outbound communication to exit out of said network device and into the network and enabling inbound communication enter into said network device from the network;
starting, via the processor, a port timer based on the opening of the port;
resetting, via the processor, the port timer based on at least one of the outbound communication exiting into the network and the inbound communication entering from the network; and
performing, via the processor, a port auditing action based on the port timer reaching a threshold.

10. The non-transitory, computer-readable media of claim 9, wherein the computer-readable instructions are capable of instructing the network device to perform the method wherein said performing the port auditing action comprises logging of the port timer reaching the threshold into a system log.

11. The non-transitory, computer-readable media of claim 9, wherein the computer-readable instructions are capable of instructing the network device to perform the method further comprising performing a second port auditing action based on the port timer reaching a second threshold.

12. The non-transitory, computer-readable media of claim 11, wherein the computer-readable instructions are capable of instructing the network device to perform the method wherein said performing the second port auditing action comprises closing the port.
